(19) United States
(12) Patent Application Publication
(10) Pub. No.: US 2002/0135843 A1
(43) Pub. Date: Sep. 26, 2002

(54) Point-to-multipoint optical access network distributed with central office interface capacity

(76) Inventor: Dumitru Gruia, San Ramon, CA (US)

Correspondence Address: Wilson & Ham, PMB: 348 2530 Berryessa Road, San Jose, CA, 95132, US

(21) Appl. No.: 09/813,715

(22) Filed: Mar. 20, 2001

(51) Int. Cl. H04B 10/00

(52) U.S. Cl. 359/167; 359/168

(57) ABSTRACT

Managing voice channels that are carried over point-to-multipoint optical networks involves distributing demand for voice channels among multiple central office interfaces that service the point-to-multipoint optical networks using a packet network connection that exists between the CO interfaces. By utilizing the packet network connection that exists between the CO interfaces, the entire capacity of all of the CO interfaces is available to service the voice channel demand of many point-to-multipoint optical networks.

### FIELD OF THE INVENTION

The invention relates generally to broadband optical communications networks, and more particularly to point-to-multipoint optical networks.

### BACKGROUND OF THE INVENTION

The explosion of the Internet and the desire to provide multiple communications and entertainment services to end users have created a need for a broadband network architecture that improves access to end users. One broadband network architecture that improves access to end-users is a point-to-multipoint passive optical network (PON). A point-to-multipoint PON is a packet, or cell, based optical access network architecture that facilitates broadband communications between an optical line terminal (OLT) and multiple remote optical network units (ONUs) over a purely passive optical distribution network. A point-to-multipoint PON utilizes passive fiber optic splitters and couplers to passively distribute optical signals between the OLT and the remote ONUs.

In order to provide economically viable optical access networks, many point-to-multipoint PONs are often aggregated together at a single access module. In addition to aggregating multiple point-to-multipoint PONs, the access modules typically provide internal switching functions and interfaces to circuit-switched and packet-switched networks. FIG. I depicts an access network architecture that includes multiple access modules 104, with each access module aggregating multiple separate point-to-multipoint PONs 106. Each of the point-to-multipoint PONs includes multiple ONUs 108 which are located near the end-user systems.

One essential service that is provided through the point-to-multipoint PONs is voice communications. In order to provide voice communications via a point-to-multipoint PON, each of the access modules 104 is connected to a Central Office (CO) 112 and telephones 110 are connected to the ONUs 108. Voice communications carried between the CO and the access module typically use traditional telecommunications protocols such as time division multiplexing (TDM), while voice communications carried between the access modules and the ONUs use packet, or cell, based protocols that transmit data in individually addressed information blocks. The dashed lines 116 represent voice communication channels that are connected from telephones 110 on the ONU side of the access network, through the respective access modules 104 and through the respective COs 112.

Because of economic considerations, the connection between a CO 112 and an access module 104 typically has a fixed voice channel capacity that is much less than the voice channel capacity of all of the point-to-multipoint PONs 106 that are connected to the access module 104. That is, there may be up to 30 possible voice channels on the point-to-multipoint PON side of the network for every one voice channel that is available at the CO interface. Known telecommunications protocols, such as GR-303, are used to manage the imbalance between the large voice channel capacity of the aggregated point-to-multipoint PONs against the smaller capacity of the CO interfaces.

Although the typical demand at a CO interface can be estimated with some degree of certainty, there is always the possibility that voice channel demand will exceed capacity. If the demand for voice channels that must utilize the CO interface at an access module exceeds the capacity of the CO interface, then some voice channels cannot be provided at the time they are needed. The ability of an optical access network to provide voice channels as they are needed is critical to product acceptance. One way to ensure voice service during periods of high voice channel demand is to increase the size of the CO interfaces between the COs and the point-to-multipoint PONs. While increasing the size of the CO interfaces will increase the voice channel capacity of the CO interfaces, the benefits of increased capacity are often times outweighed by the added cost of the additional capacity.

In view of the large imbalance between the number of possible voice channels available through the aggregation of multiple PONs and the voice channel capacity of the CO interfaces of each access module, what is needed is a system and method which can economically provide an increased number of voice channels to the CO interfaces.

### SUMMARY OF THE INVENTION

A method and system for managing voice channels that are carried over point-to-multipoint optical networks involves distributing demand for voice channels among multiple central office interfaces that service the point-to-multipoint optical networks using a packet network connection that exists between the CO interfaces. By utilizing the packet network connection that exists between the CO interfaces, the entire capacity of all of the CO interfaces is available to service the voice channel demand of many point-to-multipoint optical networks.

In an embodiment, voice channels are carried over a plurality of point-to-multipoint optical networks, wherein each of the point-to-multipoint optical networks is connected to one of a plurality of access modules. Each access module includes a central office (CO) interface, a packet network interface, and at least one optical line terminal (OLT) that is optically connected to a plurality of optical network units (ONUs) by a point-to-multipoint optical link. The plurality of access modules are connected by a packet network connection through the packet network interfaces. A method for managing the voice channels involves distributing demand for voice channels among a plurality of the CO interfaces by establishing voice channels that utilize the packet network connection to access at least one of the CO interfaces.

An embodiment of the method involves receiving channel utilization information from the plurality of CO interfaces and using the channel utilization information from the plurality of CO interfaces to determine how to distribute voice channels among the CO interfaces.

Another embodiment of the method involves receiving channel utilization information from a plurality of ONUs that are connected to the plurality of point-to-multipoint optical networks and using the channel utilization information from the plurality of ONUs to determine how to distribute voice channels among the CO interfaces.

Another embodiment of the method involves receiving channel utilization information from the plurality of CO interfaces, receiving channel utilization information from a plurality of ONUs that are connected to the plurality of point-to-multipoint optical networks, and using the channel utilization information from the plurality of CO interfaces and the channel utilization information from the plurality of ONUs to distribute voice channels such that a minimum threshold of available channel capacity is maintained at each of the CO interfaces.

Another embodiment involves establishing a voice channel having a transmission path that includes an optical link between a first ONU and a first access module, a packet network connection that connects the first access module to a second access module, and a CO interface that is part of the second access module, wherein the first and second access modules are included within the plurality of access modules. A further embodiment involves transmitting voice information between the first ONU and the CO interface that is part of the second access module via the optical link between the first ONU and the first access module and via the packet network connection that connects the first access module and the second access module. In a further embodiment, the voice information is transmitted in Internet protocol (IP) packets between the first ONU and the CO interface that is part of said second access module.

Another embodiment involves establishing IP addresses for voice-carrying IP packets which cause voice channels to utilize the packet network connection between two of the access modules.

Another method for managing voice channels that are carried over a plurality of point-to-multipoint optical networks involves distributing demand for voice channels that connect through a central office (CO) interface among a plurality of CO interfaces that service the plurality of point-to-multipoint optical networks, wherein the plurality of CO interfaces are connected by a packet network connection and establishing voice channels having transmission paths that include one of the CO interfaces, the packet network connection, and at least one of the plurality of point-to-multipoint optical networks.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 depicts an access network architecture that includes multiple access modules, with each access module aggregating multiple separate point-to-multipoint PONs in accordance with the prior art.

FIG. 2 depicts an access network architecture in which multiple access modules are physically connected by a packet network and logically connected by voice channel logic in accordance with an embodiment of the invention.

FIG. 3 depicts how the voice channel logic can distribute voice channels among a logical group of CO interfaces by switching the voice channels to different access modules through the packet network in accordance with an embodiment of the invention.

FIG. 4 is an expanded view of a logical group of access modules that are managed by voice channel logic in accordance with an embodiment of the invention.

FIG. 5 is an expanded view of an embodiment of the voice channel logic that is used to control the distribution of voice channels among the multiple CO interfaces in accordance with and embodiment of the invention.

FIG. 6 represents the channel setup processes that are carried out by the voice channel logic of FIG. 5.

FIG. 7 depicts an IP packet that supports thirty-two DS0 voice channels.

FIG. 8 is an expanded view of a DS3T that is included within the access modules of FIGS. 2-4.

FIG. 9 is an expanded view of an ONU that is optically connected to an OLT of an access module.

FIG. 10 is an expanded view of a switch module that is included within the access modules of FIGS. 2-4.

FIG. 11 is a process flow diagram of a method for managing voice channels that are carried over point-to-multipoint optical networks.

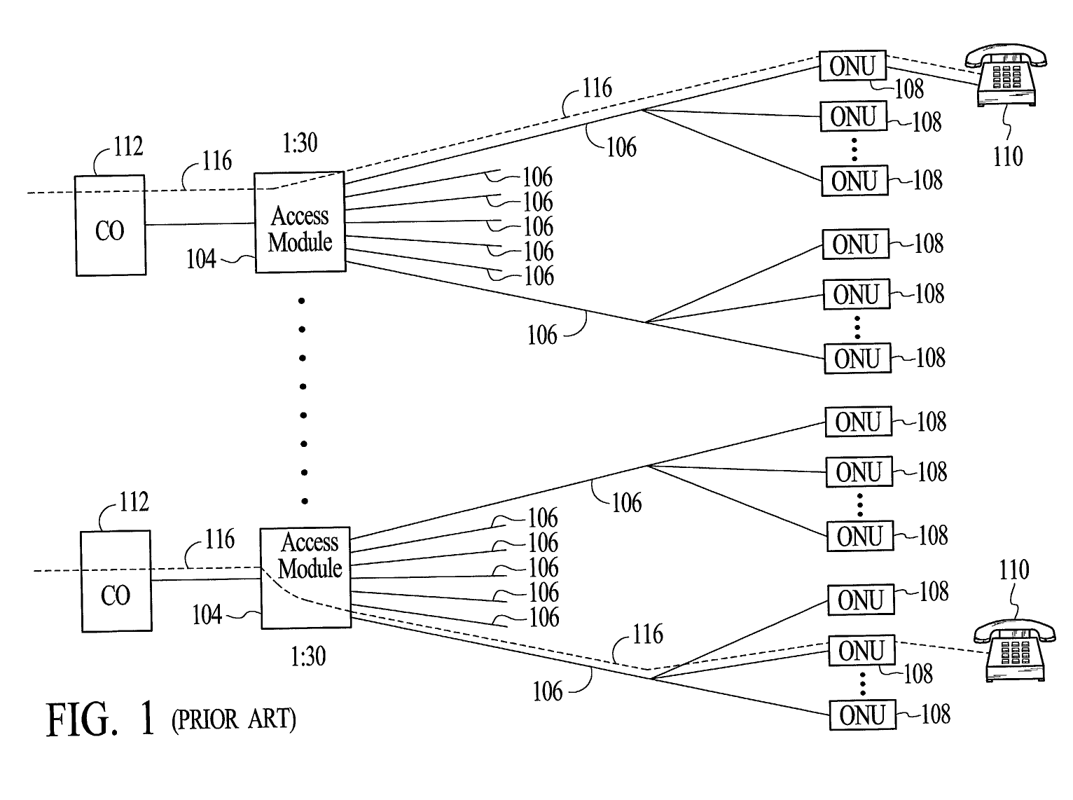

### DETAILED DESCRIPTION OF THE INVENTION

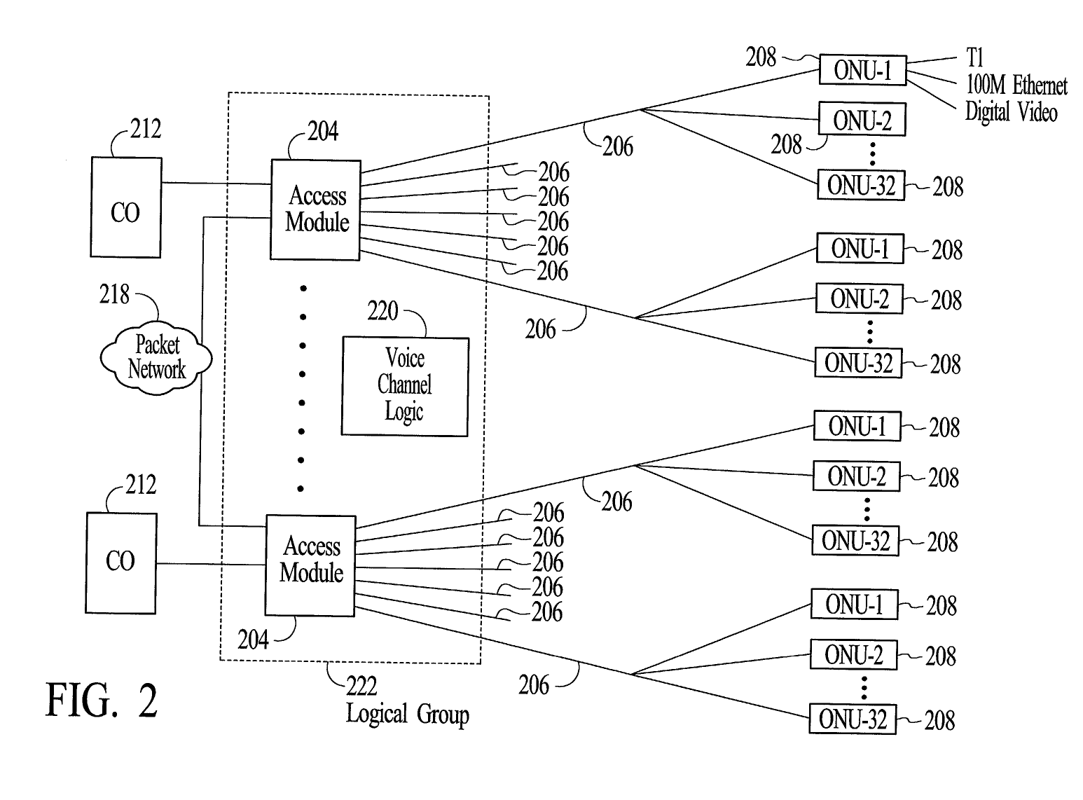

FIG. 2 depicts an access network architecture in which multiple access modules 204 are physically connected by a packet network 218 and logically connected by voice channel logic 220. In the embodiment of FIG. 2, each access module includes eight separate point-to-multipoint PONs 206 and each point-to-multipoint PON includes thirty-two ONUs 208. Each ONU has a voice channel capacity of 320 separate voice channels and therefore the total voice channel capacity on the access side of the network is 81,920 separate voice channels (8 PONs×32 ONUs/PON×320 voice channels/ONU). Each access module also includes a CO interface that provides voice channel access to the CO 212. In an embodiment, the CO is a circuit-switched telecommunications node, such as a class 5 telecommunications switch, that connects to a wide area telecommunications network. In an embodiment, the CO interface of each access module has the capacity of four DS3 connections or 2,688 separate voice channels (4 DS3s×672 channels/DS3=2,688 separate channels), where a single voice channel is commonly referred to as a DS0. For description purposes, it is assumed that the voice channel logic controls the voice channel distribution of a logical group 222 of four access modules. Given four access modules and 81,920 possible voice channels per access module, there are 327,680 possible voice channels on the ONU side of the access network and given the four CO interfaces, each having a capacity of 2,688 voice channels, there are 10,752 available voice channels through the CO interfaces. Although specific examples are described with reference to FIG. 2, it should be understood that the numbers of possible voice channels on the ONU side of the access network and the voice channel capacity of the CO interfaces may vary. Throughout the description, similar reference numbers may be used to identify similar elements.

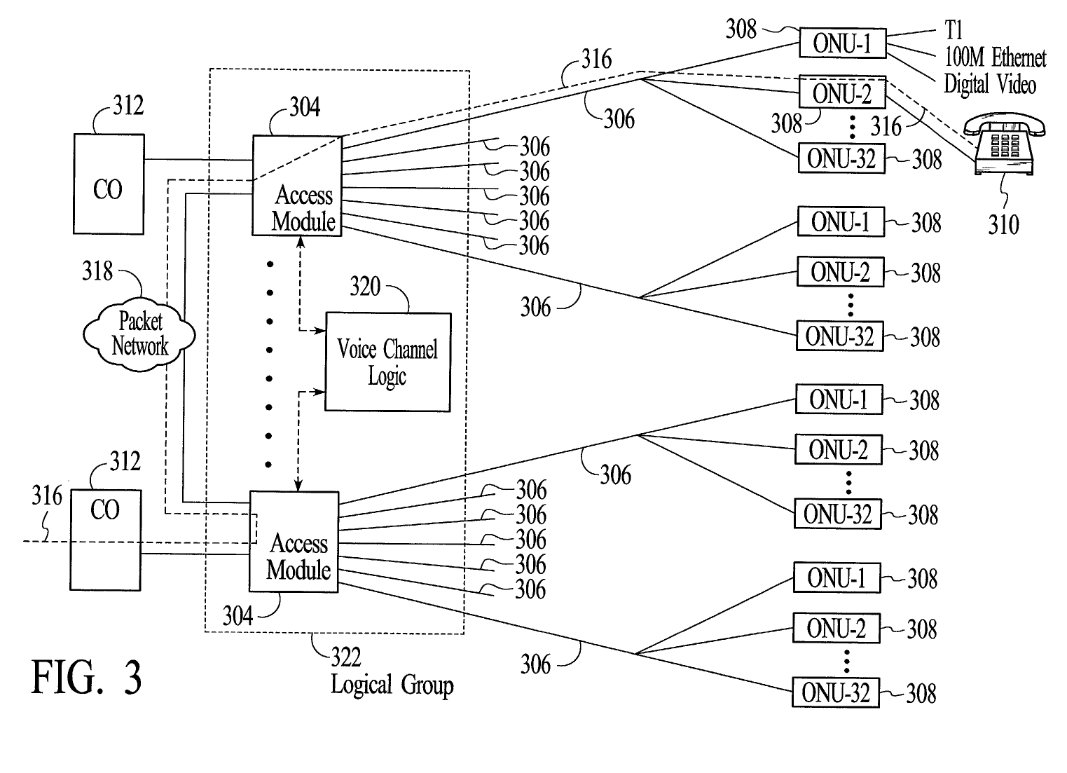

FIG. 3 depicts how the voice channel logic 320 distributes voice channels among the logical group 322 of CO interfaces by switching the voice channels to different access modules 304 through the packet network 318. As shown in FIG. 3, a voice channel 316 is established from a telephone 310, to an ONU 308, to a first access module, through the packet network, to a second access module that has available voice channel capacity at its CO interface, and then to the CO 312 that is connected to the second access module. By utilizing the packet network to switch a voice channel to a different CO interface at a different access module, excess demand for voice channels at one access module can be accommodated by a CO interface of another access module that has available capacity. That is, the total capacity of all of the CO interfaces is available to support voice channel demand of the entire logical group. Throughout the document, voice channels refer to communications channels that meet established specifications for accomplishing acceptable quality voice communications.

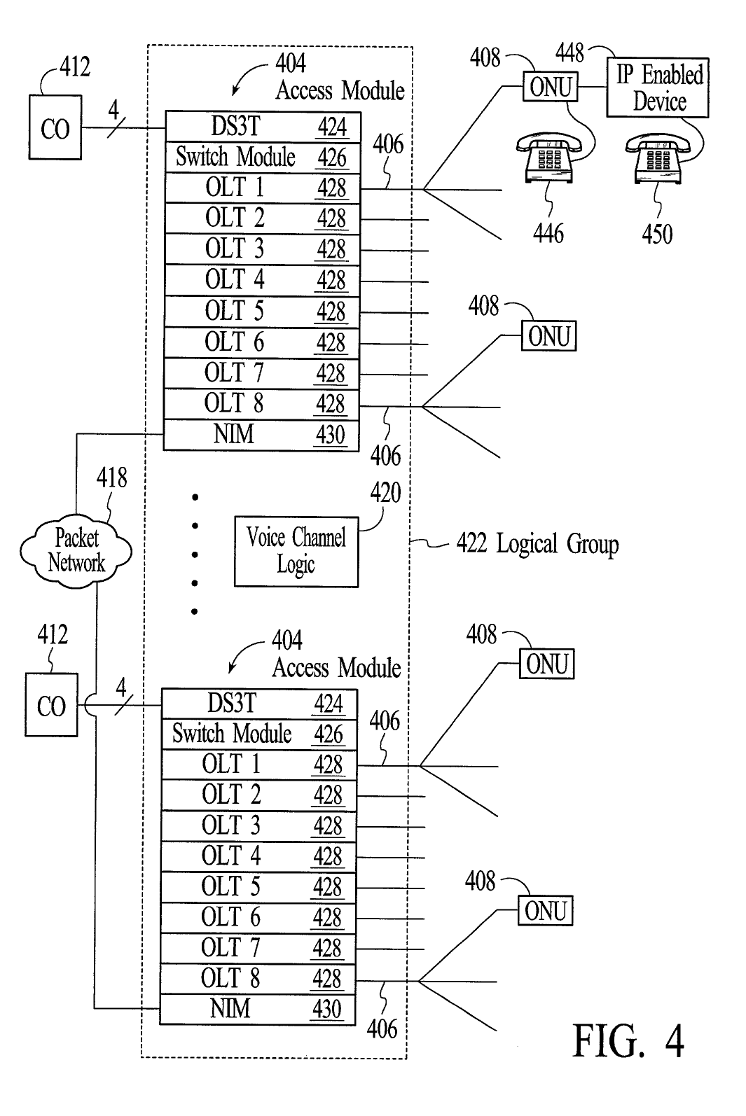

FIG. 4 is an expanded view of a logical group 422 of access modules 404 that are managed by the voice channel logic 420. In the embodiment of FIG. 4, each access module includes a CO interface 424 (referred to as the DS3 Terminal or “DS3T”), a switch module 426, eight OLTs 428, and a network interface module 430 (NIM). In the embodiment of FIG. 4, the access modules are chassis-based systems and the DS3Ts, the switch modules, the OLTs, and the NIMs are embodied in slot cards that are inserted into the access module chassis. The OLTs within each access module are the common communications point for all of the ONUs 408 on the OLT-specific point-to-multipoint PON 406. The OLTs transmit information blocks downstream to all of the ONUs on the optical link and receive upstream transmissions from all of the ONUs on the optical link. Each of the OLTs is connected to the switch module so that information blocks can be exchanged within the respective access module. In an embodiment, information is transmitted between the OLTs and ONUs in variable-length packets that are formatted according to the IEEE 802.3 standard (commonly referred to as Ethernet) or any of the related IEEE 802.3x sub-standards. In an embodiment, the variable-length packets are transmitted at a rate of 1 gigabit per second (Gb/s) as defined by IEEE 802.3z (commonly referred to as gigabit Ethernet), although lower or higher transmission rates may be utilized.

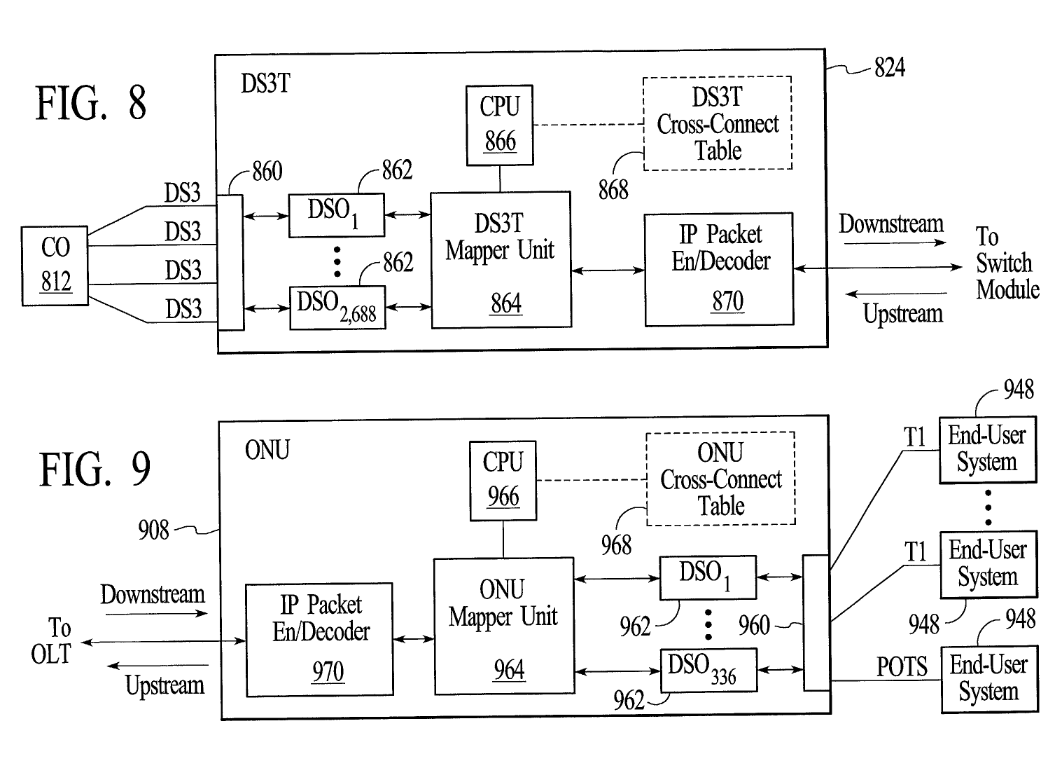

The DS3T 424 within each access module 404 is the interface between the protocol that is used to carry voice channels to the CO 412 (i.e., circuit switching) and the protocol, such as Ethernet, that is used to carry voice channels throughout the access module and the point-to-multipoint PONs 406. In the embodiment of FIG. 4, the DS3T module includes the channel capacity of four DS3 connections, or 2,688, individual voice channels (DS0s). As is described below with reference to FIG. 8, the DS3T within each access module includes a CPU for processing the voice channels and a cross connect table which indicates how the voice channels of the CO interface are being utilized.

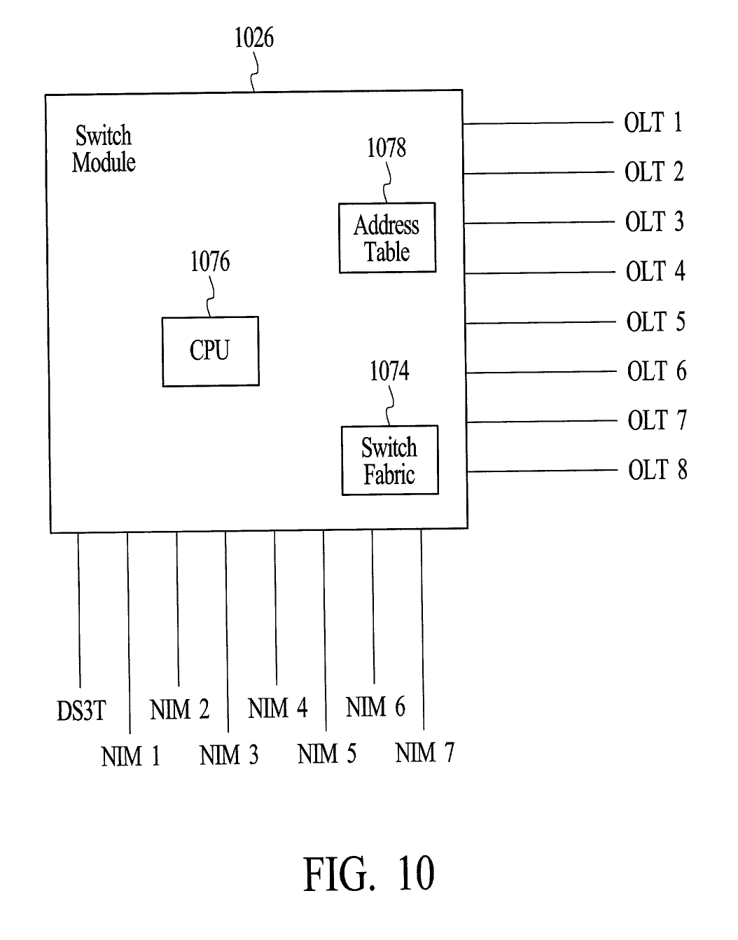

The switch module 426 within each access module is the switching engine for packetized information within the access module 404. The switch module is connected to the DS3T 424, the NIM 430, and all of the OLTs 428. In an embodiment, the switch module includes a CPU, a switch fabric, and address tables that enable the switch module to manage the packet traffic from all of the slot cards. The switch module is described in more detail below with reference to FIG. 10. In an embodiment, the switch module is an Ethernet-based switch.

The NIM 430 within each access module 404 includes interfaces to other networks, such as networks that operate according to packet, or cell, based protocols. In the embodiment of FIG. 4, the NIMs include interfaces to the packet network 418 that allow access to each of the other access modules and to other packet networks. Protocols supported by the NIMs may include Ethernet, IP, ATM, and SONET. In the embodiments of FIGS. 2-4, the access modules 204, 304, and 404 are connected to different COs 212, 312, and 412. In some applications the access modules in the logical group 222, 322, and 422 of access modules may be located in, and connected to, the same CO and in other applications, the access modules may be located in, and connected to, physically separate COs depending on the density of subscribers and the proximity of COs. Whether the access modules are connected to the same CO or different COs, the access modules can communicate with each other via the packet networks 218, 318, and 418.

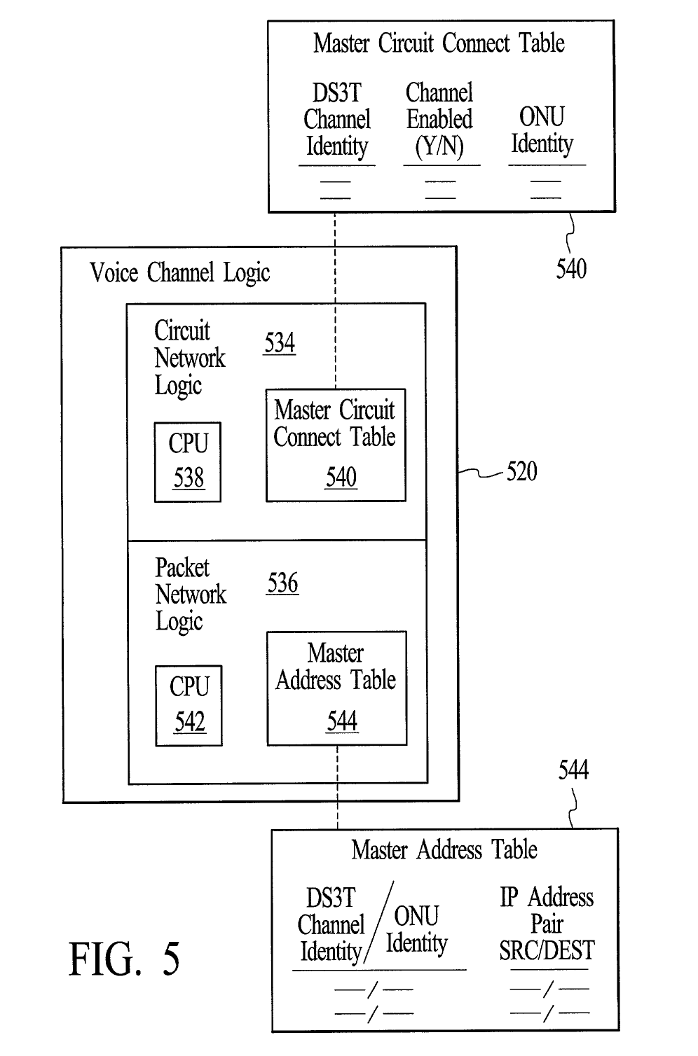

FIG. 5 is an expanded view of an embodiment of the voice channel logic 520 that is used to control the distribution of voice channels among the DS3Ts (CO interfaces). Functional units within the voice channel logic include circuit network logic 534 and packet network logic 536. The circuit network logic manages the setup and distribution of voice channels among the DS3Ts within the logical group 222, 322, and 422 of access modules. The packet network logic manages the addressing of the packets that carry the voice channels that have been setup by the circuit network logic. Although the voice channel logic is depicted as a discrete unit in FIGS. 2-5, in an embodiment the voice channel logic is actually distributed among the access modules. That is, the voice channel logic does not exist in one discrete location because the functions performed by the voice channel logic are carried out by functional units within the access modules in the logical group of access modules. Distribution of the voice channel logic among the access modules is described below with reference to FIGS. 8-10.

The circuit network logic shown in FIG. 5 is distributed across the DS3Ts, in the logical group 422 of access modules 404 as shown in FIG. 4, and functionally includes a CPU 538 and a master circuit connect table 540. In an embodiment, the master circuit connect table identifies how all of the voice channels of the combined DS3Ts are being utilized. As shown in the expanded view, the master circuit connect table identifies the status (either enabled or not enabled) of all of the DS3T voice channels and the identity of each ONU that is utilizing an enabled DS3T voice channel. The master circuit connect table is kept current with channel utilization information that is constantly being received from the DS3Ts and the ONUs. The CPU utilizes the master circuit connect table to determine how to distribute requests for new voice channels that must utilize a CO interface. Requests for new voice channels can be received from both the CO and the ONU sides of the access module. When requests for new voice channels are received, the CPU of the circuit network logic analyzes the requests and the information in the master circuit connect table to determine how to setup the requested voice channels in a way that best utilizes the limited CO interfaces of the DS3Ts. In an embodiment, the circuit network logic utilizes the GR-303 protocol to manage channel setup and concentration functions. Channel identification information for newly setup voice channels is generated by the circuit network logic. Channel identification information for a newly setup voice channel may include the identity of the DS3T and the identity of the ONU through which the voice channel is setup. Every time a new voice channel is setup by the circuit network logic, the CPU of the circuit network logic updates the master circuit connect table.

There are many parameters that may be considered by the circuit network logic 534 in determining the best way to setup the requested voice channels. In an embodiment, minimum thresholds are established for the DS3Ts that indicate the minimum number of channels that should be available at any time. It may be desirable to always have the capacity to add new voice channels at a DS3T to accommodate for sudden surges in call demand or to accommodate certain high priority calls such as calls for emergency services. When minimum thresholds are a parameter to consider, the circuit network logic can distribute new voice channels among the DS3Ts via the packet network in a manner that attempts to maintain the required number of available channels at each DS3T. That is, the circuit network logic can be programmed to distribute high demand for voice channels at one CO interface to another CO interface that is experiencing lower demand for voice channels.

In another embodiment, the circuit network logic 534 distributes new voice channels among the DS3Ts in a manner that creates an even distribution of voice channels among the DS3Ts in the logical group. Other distribution logic may include switching channels to different DS3Ts in a particular priority order such that each DS3T has a preferred distribution priority. That is, it may be more efficient to switch voice channels to a particular access module in the logical group over other access modules in the logical group because of, for example, proximity of the access modules to each other or voice channel use patterns. For example, it may be desirable to switch voice channels from an access module that has a subscriber base of primarily businesses to an access module that has a subscriber base of primarily residences during business hours instead of switching the voice channels to another access module that has a primarily business subscriber base. Voice channels from businesses could be switched to primarily residential access modules because the demand for voice channels (and therefore the CO interfaces) is typically lower in residential areas during business hours. The reverse approach could be applied during non-business hours when residential voice channel demand is higher.

In an embodiment, the circuit network logic 534 operates in the following manner. A request for new channels is received at one of the DS3Ts and the receiving DS3T determines whether or not the request can be serviced by the DS3T. That is, whether or not the DS3T has a sufficient number of available channels at its CO interface. In an embodiment, the determination involves checking a DS3T-specific cross-connect table that is maintained by each DS3T. If the DS3T has enough available channels, the request is handled by the receiving DS3T. However, if the DS3T does not have enough available channels or prefers not to service the request, then the DS3T passes the request on to another one of the DS3Ts in the logical group of DS3Ts. The next DS3T to receive the request goes through the same process as the DS3T that first received the request. The process of passing the request to a different DS3T is continued until the request is serviced by a DS3T in the logical group or until the request is denied. Even though each DS3T individually determines whether or not to service a request and passes requests that are not serviced, the overall effect is that of circuit network logic that is distributed among the DS3Ts. Likewise, although one master circuit connect may not physically exist, a master circuit connect table is logically produced as a request is passed to different DS3Ts and evaluated by the DS3Ts.

The packet network logic 536 uses the channel identification information of newly setup voice channels to determine packet addresses for the packets that will carry the voice channels through the packet-based transmission paths. The packet network logic is distributed across the switch modules 426 in the logical group 422 of access modules and includes a CPU 542 and a master address table. The master address table maps the channel identification information (provided by the circuit network logic) of voice channels to particular header addresses within the packet network. As shown in the expanded view of the master address table, the master address table maps the target DS3T and ONU of a voice channel to an IP address pair. In an embodiment, one IP address of the IP address pair is the IP address of the ONU where the voice channel originates or terminates. That is, referring to FIG. 4, one IP address of an IP address pair for a voice channel is the IP address of the DS3T 424 (CO interface) in the access module 404 that provides access to the CO and the other IP address is the IP address of the ONU 408 that supports the telephone 446. In an alternative embodiment, one IP address of the IP address pair may be the IP address of an IP-enabled end-user system 448 that is between the ONU and a telephone 450.

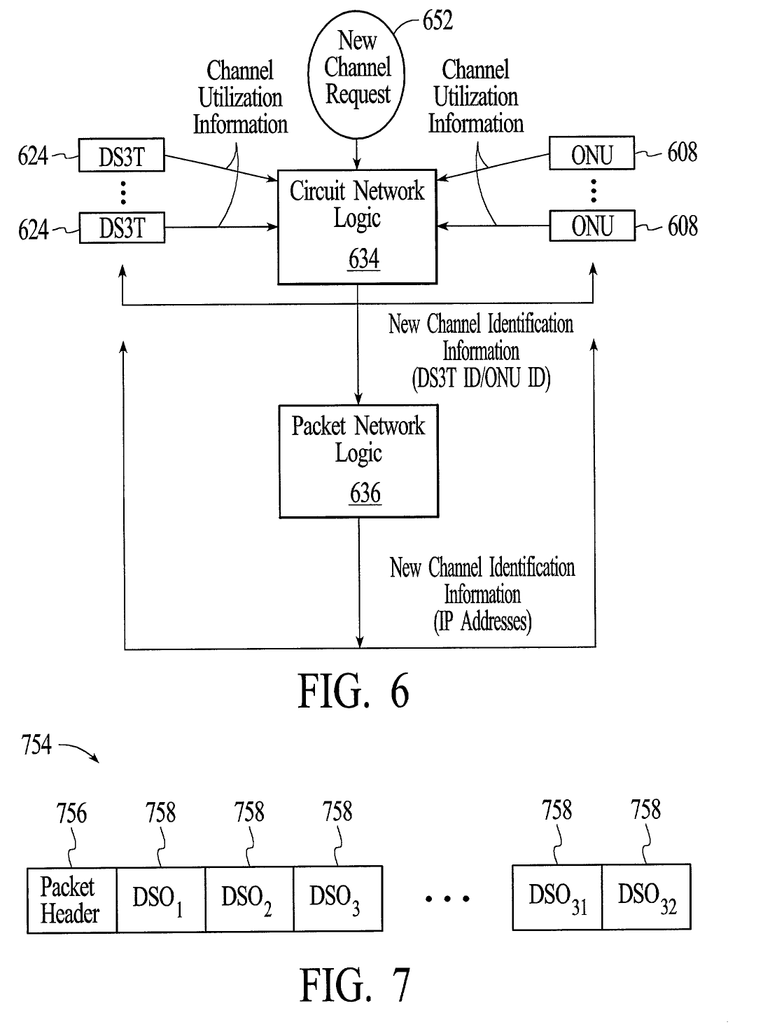

FIG. 6 represents the channel setup processes that are carried out by the voice channel logic 520 of FIG. 5. Referring to the left side of FIG. 6, the circuit network logic 634 receives channel utilization information from the DS3Ts 624 that identifies how the DS3T voice channels (CO interface voice channels) are being utilized. Referring to the right side of FIG. 6, the circuit network logic also receives channel utilization information from the ONUs 608 that identifies how the ONU voice channels are being utilized. The circuit network logic uses the channel utilization information from the DS3Ts and the ONUs to maintain the master circuit connect table. Requests 652 for new voice channels may be received by the circuit network logic from either the DS3Ts or the ONUs. Upon receiving requests for new channels to be setup, the circuit network logic considers the master circuit connect table and any other decision parameters in determining how to distribute new channel requests among the DS3Ts in the logical group of access modules that is managed by the voice channel logic.

Once the circuit network logic has determined which DS3Ts will support the new voice channels, the circuit network logic outputs new channel identification information for the new channels to the DS3Ts, to the ONUs, and to the packet network logic 636. The DS3Ts and the ONUs update their local utilization tables and the packet network logic maps the new channel identification information to a packet address pair. In an embodiment, the packet network logic maps the new channel identification information to an IP address pair. The IP address pair is then fed back to the appropriate DS3Ts and ONUs SO that the IP address pair can be used when generating packets that carry the respective voice channel between the identified DS3T and the respective ONU. In an embodiment where an IP-enabled end-user system is connected to an ONU, the IP address pair used for the packets that carry the voice channel identifies the DS3T and the respective IP-enabled end-user system.

Once voice channels are setup, in the downstream direction, voice-carrying IP packets are generated at the DS3Ts. The destination IP address of the voice-carrying IP packets identify the ONU that is the destination of the voice information. The packet network is utilized by voice-carrying IP packets that must cross over to a different access module to reach the target ONU (as shown by the voice channel 316 in FIG. 3). In the upstream direction, voice-carrying IP packets are generated at the ONUs. The destination IP address of the voice-carrying IP packets identifies the DS3T that is providing the CO interface. Again the packet network is utilized by voice-carrying IP packets that must cross over to a different access module to reach the target DS3T (as shown by the voice channel 316 in FIG. 3). Because the voice channels are inserted into IP packets at the input to the packet network (i.e., at a DS3T or an ONU), and because the access modules are all connected by a packet network, the voice-carrying IP packets can be rapidly and efficiently switched between access modules and the ONUs without having to disassemble the voice-carrying IP packets.

For efficiency purposes, multiple voice channels are typically grouped together and carried across the point-to-multipoint PONs in the same IP packet. In the optical access network described above, up to thirty-two different voice channels are grouped together and carried in the same IP packet. FIG. 7 depicts an IP packet 754 that supports thirty-two DS0 voice channels. The IP packet includes a header 756 and thirty-two time slots 758 that carry portions (i.e., sixteen bytes per channel) of the thirty-two DS0 voice channels (DS0₁-DS0₃₂). In order to avoid the need to break up packets while they are handled in the access modules, voice channels are switched between access modules in groups of up to thirty-two voice channels. That is, all of the channels in the same packet are carried between the same DS3T and the same ONU.

FIG. 8 is an expanded view of a DS3T 824 that is included within the access modules. Relevant functional units within the DS3T include a DS3 interface 860, DS0 channel buffers 862, a DS3T mapper unit 864, a CPU 866, a DS3T cross-connect table 868, and an IP packet encoder/decoder (en/decoder) 870. The DS3 interface provides an interface between the incoming DS3 connections and the DS3T module. The DS0 channel buffers are channel-specific buffers. In the embodiment of FIG. 8, each DS3T has 2,688 different channels, with each channel having a channel-specific buffer (buffers DS0₁-DS0_{2,688}) that can store up to 32 bytes each. The DS3T cross-connect table identifies which ONUs are utilizing which DS0 channel buffers. The DS3T cross-connect table is maintained by the CPU in response to channel setup decisions made by the CPU and channel utilization information received from the ONUs. The DS3T mapper unit relates DS0 channels (and the respective DS0 channel buffers) to ONUs. In the downstream direction, the DS3T mapper unit maps each active DS0 channel buffer to a particular ONU according to the DS3T cross-connect table. In the upstream direction, the DS3T mapper unit maps DS0 channels from the ONUs to the appropriate DS0 channel buffers.

The IP packet en/decoder 870 provides the interface between the packet-based network and the circuit-based network. In the downstream direction, the IP packet en/decoder generates voice-carrying IP packets addressed to the ONUs that are to receive the respective voice channels. In an embodiment, voice-carrying IP packets include up to thirty-two different voice channels, including up to sixteen bytes of voice information for each of the thirty-two voice channels. In an embodiment, new voice-carrying IP packets are generated every 2 milliseconds for each enabled DS0 channel. When voice channels are switched to a different access module, the IP packet en/decoder generates voice-carrying IP packets that are addressed to ONUs of other access modules. The voice-carrying IP packets are then routed through the IP network from the DS3T of one access module to another access module and eventually to the target ONU.

In the upstream direction, the IP packet en/decoder extracts the different voice channels from the received voice-carrying IP packets and delivers the extracted voice channels to the DS3T mapper unit. The DS3T mapper unit writes the voice channels to the corresponding DS0 channel buffers. The voice channels are eventually forwarded through the DS3 interface to one of the DS3 connections and then to the CO 812. Although the DS0 channel buffers, the DS3T mapper unit, and the IP packet en/decoder are shown as bi-directional units, an embodiment of the DS3T may utilize dedicated upstream and downstream DS0 channel buffers, mapper units, and IP packet en/decoders.

As described above with reference to FIG. 5, the circuit network logic is distributed among all of the DS3Ts in the logical group of access modules. The master circuit-connect table 540 of the circuit network logic 534 is formed by the combination of DS3T cross-connect tables from each of the DS3Ts in the logical group. In an embodiment, the CPU 538 and the master circuit-connect table of the circuit network logic are embodied within the CPUs 866 and the DS3T cross-connect tables 868 of all of the DS3Ts in the group of access modules that is managed by the voice channel logic.

FIG. 9 is an expanded view of an ONU 908 that is optically connected to an OLT of an access module. Relevant functional units within the ONU include an end-user interface 960, DS0 channel buffers 962, an ONU mapper unit 964, a CPU 966, an ONU cross-connect table 968, and an IP packet encoder/decoder (en/decoder) 970. The end-user interface provides an interface between end-user systems 948 and the ONU. In the downstream direction, the end-user interface directs buffered data to the proper T1/E1 and POTS framers. In the upstream direction, the end-user interface directs voice channels to their respective DS0 channel buffers. The DS0 channel buffers are channel-specific buffers. In the embodiment of FIG. 9, each ONU includes up to 336 channel-specific buffers (DS0₁-DS0₃₃₆) that can store up to 8 bytes each. In the embodiment of FIG. 9, the ONU has up to ten T1/E1 connections (for a total of 320 DS0s) and up to sixteen POTS connections for a combined total of 336 different DS0 voice channels. Although the ONU supports 336 different DS0 voice channels, a maximum of 320 DS0 voice channels can be simultaneously enabled in the embodiment of FIG. 9. The ONU cross-connect table identifies which DS0 channel buffers are enabled. The ONU cross-connect table is maintained by the CPU in response to channel utilization information received from the DS3T and new channel requests received from the end-user systems. The ONU mapper unit relates DS0 channels (and the respective DS0 channel buffers) to voice-carrying IP packets. In the downstream direction, the ONU mapper unit maps each voice channel to its respective DS0 channel buffer according to the ONU cross-connect table. In the upstream direction, the ONU mapper unit transfers data blocks from the enabled DS0 channel buffers to the IP packet en/decoder.

The IP packet en/decoder 970 provides the interface between the packet-based network and the circuit-based network. In the upstream direction, the IP packet en/decoder generates voice-carrying IP packets addressed to the DS3Ts that are to receive the respective voice channels. In an embodiment, a voice-carrying IP packet is generated every 2 milliseconds for each enabled DS0 channel. As described above with reference to FIG. 7, each voice-carrying IP packet can include up to thirty-two different DS0 voice channels such that the payload of a voice-carrying IP packet with thirty-two different DS0 voice channels includes up to 512 bytes (16 bytes/channel×32 channels/packet=512 bytes/packet). When voice channels are to be switched to a different access module, the IP packet en/decoder generates voice-carrying IP packets that are addressed to the DS3T of the different access module. Voice-carrying IP packets that are to be switched to a different DS3T are sent upstream to the OLT, then they are routed through the IP network to the DS3T of the target CO interface. In the downstream direction, the IP packet en/decoder extracts the different voice channels from the received voice-carrying IP packets and delivers the extracted voice channels to the ONU mapper unit. The ONU mapper unit writes the voice channels to the corresponding DS0 channel buffers as indicated by the ONU cross-connect table. The voice channels are eventually forwarded through the end-user interface 960 to one of the end-user systems 948. Although the DS0 channel buffers, the ONU mapper unit, and the IP packet en/decoder are shown as bi-directional units, an embodiment of the ONU may utilize dedicated upstream and downstream DS0 channel buffers, mapper units, and IP packet en/decoders.

The ONU cross-connect tables from all of the ONUs in the group of access modules are utilized to maintain the master circuit-connect table 540 that is described with reference to FIG. 5. In an embodiment, the CPU 966 of each ONU 908 updates their respective ONU cross-connect table 968. The ONU cross-connect tables from all of the ONUs are continuously forwarded to the respective DS3Ts and are used to update the DS3T cross-connect tables. Logically, the circuit network logic that is running across the group of DS3Ts uses the ONU cross-connect tables to update the master circuit-connect table.

FIG. 10 is an expanded view of the switch module 1026 that is included within each access module. In the embodiment of FIG. 10, the switch module includes sixteen ports; one port for each of eight OLTs, seven ports for the network interface module, and one port for the DS3T. Relevant functional units within the switch module include a switch fabric 1074, a CPU 1076, and an address table 1078. The switch fabric provides the connection pathways between the ports. The address table provides source and destination addresses for packets that are being forwarded through the switch module. The CPU updates the address table and controls switching within the switch fabric. In an embodiment, the switch module is capable of performing layer 2 switching based on MAC addresses and layer 3 routing based on IP addresses.

Referring back to FIG. 5, the function of the packet network logic 536 is distributed across all of the switch modules in the logical group. In an embodiment, the master address table 544 is logically formed by aggregating all of the address tables 1078 from the individual switch modules 1026. Likewise, the function of the packet network logic's CPU 542 is distributed across all of the switch module CPUs 1076 in the group of access modules.

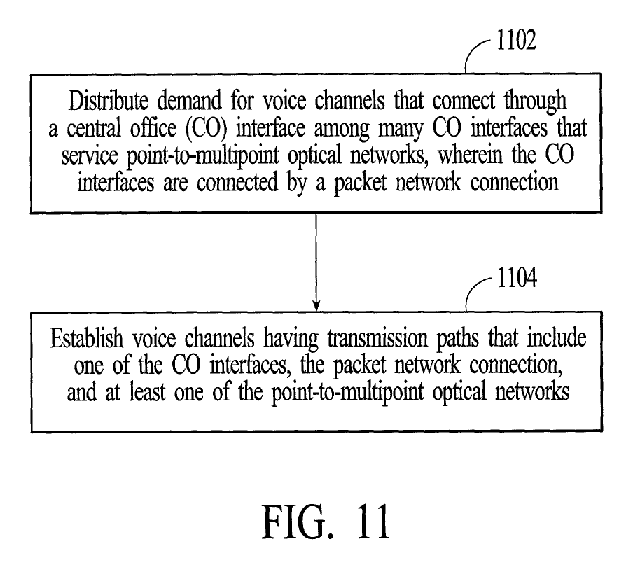

FIG. 11 is a process flow diagram of a method for managing voice channels that are carried over many point-to-multipoint optical networks. At step 1102, demand for voice channels that connect through a central office (CO) interface is distributed among many CO interfaces that service the point-to-multipoint optical networks, wherein the CO interfaces are connected by a packet network connection. At step 1104, voice channels having transmission paths that include one of the CO interfaces, the packet network connection, and at least one of the point-to-multipoint optical networks are established.

Referring back to FIGS. 2-4, each of the point-to-multipoint PONs 206, 306, and 406 have a tree topology that includes a common optical fiber (trunk fiber) and multiple ONU-specific fibers that are connected by a passive optical splitter/coupler. In alternative embodiments, an active splitter/coupler may replace the passive splitter/coupler. An optical signal transmitted in the downstream direction (from an access module to the ONUs) is optically split into multiple ONU-specific optical signals that all carry the same information. Optical signals transmitted in the upstream direction (from the ONUs to the access modules) are optically coupled into the trunk fiber that is connected between the coupler and the OLT. In an embodiment, time division multiplexing is utilized in the upstream direction to prevent collisions of upstream transmissions from two or more ONUs.

Although the point-to-multipoint PONs 206, 306, and 406 have a tree topology, alternative network topologies are possible. Alternative network topologies include a bus topology and a ring topology. In addition, although the distribution network of FIGS. 2, 3 and 4 depicts only single fiber connections between network components, redundant fibers may be added between network components to provide fault protection.

Although the voice channel management system and method for point-to-multipoint PONs is described with reference to a variable-length packet protocol such as Ethernet, the system and method could also be applied to fixed-length packet protocols such as ATM.

What is claimed is:

1. A method for managing voice channels that are carried over a plurality of point-to-multipoint optical networks, wherein each of said point-to-multipoint optical networks is connected to one of a plurality of access modules, each access module including a central office (CO) interface, a packet network interface, and at least one optical line terminal (OLT) that is optically connected to a plurality of optical network units (ONUs) by a point-to-multipoint optical link, said plurality of access modules being connected by a packet network connection through said packet network interfaces, said method comprising:
distributing demand for voice channels among a plurality of said CO interfaces by establishing voice channels that utilize said packet network connection to access at least one of said CO interfaces.

2. The method of claim 1 wherein said step of distributing demand for voice channels among a plurality of CO interfaces includes steps of:
receiving channel utilization information from said plurality of CO interfaces; and
using said channel utilization information from said plurality of CO interfaces to determine how to distribute voice channels among said CO interfaces.

3. The method of claim 1 wherein said step of distributing demand for voice channels among a plurality of CO interfaces includes steps of:
receiving channel utilization information from a plurality of ONUs that are connected to said plurality of point-to-multipoint optical networks; and
using said channel utilization information from said plurality of ONUs to determine how to distribute voice channels among said CO interfaces.

4. The method of claim 1 wherein said step of distributing demand for voice channels among a plurality of CO interfaces includes steps of:
receiving channel utilization information from said plurality of CO interfaces;
receiving channel utilization information from a plurality of ONUs that are connected to said plurality of point-to-multipoint optical networks; and
using said channel utilization information from said plurality of CO interfaces and said channel utilization information from said plurality of ONUs to distribute voice channels such that a minimum threshold of available channel capacity is maintained at each of said CO interfaces.

5. The method of claim 1 further including a step of establishing a voice channel having a transmission path that includes an optical link between a first ONU and a first access module, a packet network connection that connects said first access module to a second access module, and a CO interface that is part of said second access module, wherein said first and second access modules are included within said plurality of access modules.

6. The method of claim 5 further including a step of transmitting voice information between said first ONU and said CO interface that is part of said second access module via said optical link between said first ONU and said first access module and via said packet network connection that connects said first access module and said second access module.

7. The method of claim 6 wherein said voice information is transmitted in Internet protocol (IP) packets between said first ONU and said CO interface that is part of said second access module.

8. The method of claim 1 wherein said step of distributing demand for voice channels among a plurality of CO interfaces includes a step of establishing IP addresses for voice-carrying IP packets which cause voice channels to utilize said packet network connection between two of said access modules.

9. A method for managing voice channels that are carried over a plurality of point-to-multipoint optical networks comprising:
distributing demand for voice channels that connect through a central office (CO) interface among a plurality of CO interfaces that service said plurality of point-to-multipoint optical networks, wherein said plurality of CO interfaces are connected by a packet network connection; and
establishing voice channels having transmission paths that include one of said CO interfaces, said packet network connection, and at least one of said plurality of point-to-multipoint optical networks.

10. The method of claim 9 wherein said step of distributing demand for voice channels among a plurality of CO interfaces includes steps of:
receiving channel utilization information from said plurality of CO interfaces;
receiving channel utilization information from a plurality of ONUs that are connected to said plurality of point-to-multipoint optical networks; and
using said channel utilization information from said plurality of CO interfaces and said channel utilization information from said plurality of ONUs to determine how to distribute voice channels among said CO interfaces.

11. The method of claim 9 wherein said step of distributing demand for voice channels among a plurality of CO interfaces includes steps of:
receiving channel utilization information from said plurality of CO interfaces;
receiving channel utilization information from a plurality of ONUs that are connected to said plurality of point-to-multipoint optical networks; and
using said channel utilization information from said plurality of CO interfaces and said channel utilization information from said plurality of ONUs to distribute voice channels such that a minimum threshold of available channel capacity is maintained at each of said CO interfaces.

12. The method of claim 9 wherein said step of establishing voice channels includes a step of establishing IP addresses for voice-carrying IP packets which cause transmission paths to include one of said CO interfaces, said packet network connection, and at least one of said plurality of point-to-multipoint optical networks.

13. A system for managing voice channels that are carried over a plurality of point-to-multipoint optical networks, wherein each of said point-to-multipoint optical networks is connected to one of a plurality of access modules, each access module including a central office (CO) interface, a packet network interface, and at least one optical line terminal (OLT) that is optically connected to a plurality of optical network units (ONUs) by a point-to-multipoint optical link, said plurality of access modules being connected by a packet network connection through said packet network interfaces, said system comprising:
means for distributing demand for voice channels among a plurality of said CO interfaces by establishing voice channels that utilize said packet network connection to access at least one of said CO interfaces.

14. The system of claim 13 wherein said means for distributing demand for voice channels among a plurality of CO interfaces includes means for:
receiving channel utilization information from said plurality of CO interfaces; and
using said channel utilization information from said plurality of CO interfaces to determine how to distribute voice channels among said CO interfaces.

15. The system of claim 13 wherein said means for distributing demand for voice channels among a plurality of CO interfaces includes means for:
receiving channel utilization information from a plurality of ONUs that are connected to said plurality of point-to-multipoint optical networks; and
using said channel utilization information from said plurality of ONUs to determine how to distribute voice channels among said CO interfaces.

16. The system of claim 13 wherein said means for distributing demand for voice channels among a plurality of CO interfaces includes means for:
receiving channel utilization information from said plurality of CO interfaces;
receiving channel utilization information from a plurality of ONUs that are connected to said plurality of point-to-multipoint optical networks; and
using said channel utilization information from said plurality of CO interfaces and said channel utilization information from said plurality of ONUs to distribute voice channels such that a minimum threshold of available channel capacity is maintained at each of said CO interfaces.

17. The system of claim 13 further including means for establishing a voice channel having a transmission path that includes an optical link between a first ONU and a first access module, a packet network connection that connects said first access module to a second access module, and a CO interface that is part of said second access module, wherein said first and second access modules are included within said plurality of access modules.

18. The system of claim 17 further including means for transmitting voice information between said first ONU and said CO interface that is part of said second access module via said optical link between said first ONU and said first access module and via said packet network connection that connects said first access module and said second access module.

19. The system of claim 18 wherein said voice information is transmitted in Internet protocol (IP) packets between said first ONU and said CO interface that is part of said second access module.

20. The system of claim 13 wherein said means for distributing demand for voice channels among a plurality of CO interfaces includes means for establishing IP addresses for voice-carrying IP packets which cause voice channels to utilize said packet network connection between two of said access modules.

21. A system for managing voice channels that are carried over a plurality of point-to-multipoint optical networks comprising:
means for distributing demand for voice channels, that connect through a central office (CO) interface, among a plurality of CO interfaces that service said plurality of point-to-multipoint optical networks, wherein said plurality of CO interfaces are connected by a packet network connection; and
means for establishing voice channels having transmission paths that include one of said CO interfaces, said packet network connection, and at least one of said plurality of point-to-multipoint optical networks.

22. The system of claim 21 wherein said means for distributing demand for voice channels among a plurality of CO interfaces includes means for:
receiving channel utilization information from said plurality of CO interfaces;
receiving channel utilization information from a plurality of ONUs that are connected to said plurality of point-to-multipoint optical networks; and
using said channel utilization information from said plurality of CO interfaces and said channel utilization information from said plurality of ONUs to determine how to distribute voice channels among said CO interfaces.

23. The system of claim 21 wherein said means for distributing demand for voice channels among a plurality of CO interfaces includes means for:
receiving channel utilization information from said plurality of CO interfaces;
receiving channel utilization information from a plurality of ONUs that are connected to said plurality of point-to-multipoint optical networks; and
using said channel utilization information from said plurality of CO interfaces and said channel utilization information from said plurality of ONUs to distribute voice channels such that a minimum threshold of available channel capacity is maintained at each of said CO interfaces.

24. The system of claim 21 wherein said means for establishing voice channels includes means for establishing IP addresses for voice-carrying IP packets which cause transmission paths to include one of said CO interfaces, said packet network connection, and at least one of said plurality of point-to-multipoint optical networks.

25. A system for managing voice channels that are carried over point-to-multipoint optical networks comprising:
a plurality of access modules, wherein each access module aggregates a plurality of point-to-multipoint optical networks;
a packet network connection that links said plurality of access modules to each other;
each of said plurality of access modules including:
a CO interface that links voice channels to a CO;
a plurality of point-to-multipoint optical networks with each point-to-multipoint optical network including an optical line terminal (OLT) that is optically connected to a plurality of optical network units (ONUs) via an OLT-specific point-to-multipoint optical link; and
a packet network interface that links said access module to said packet network connection; and
means, associated with said plurality of access modules, for establishing a voice channel having a transmission path that includes an ONU that is connected to a first access module, said packet network connection, and a CO interface of a second access module, wherein said first and second access modules are included within said plurality of access modules.

26. The system of claim 25 wherein said means for establishing a voice channel includes means for distributing demand for voice channels among said plurality of CO interfaces so that the total capacity of said plurality of CO interfaces is available to support voice channel demand for any of said ONUs.

27. The system of claim 25 wherein said means for establishing a voice channel includes means for distributing demand for voice channels at the CO interface of said first access module to the CO interface of said second access module.

28. The system of claim 25 wherein said means for establishing a voice channel includes means for distributing demand for voice channels among said plurality of CO interfaces so that a minimum threshold of available channel capacity is maintained at each of said CO interfaces.

29. The system of claim 25 wherein said means for establishing a voice channel includes circuit network logic for determining which of said plurality of CO interfaces should be utilized to establish a new voice channel.

30. The system of claim 29 wherein said circuit network logic receives channel utilization information from said plurality of CO interfaces.

31. The system of claim 29 wherein said circuit network logic receives channel utilization information from said ONUs.

32. The system of claim 25 wherein said means for establishing a voice channel includes packet network logic for establishing protocol addresses which cause said transmission path to include said ONU that is connected to said first access module, said packet network connection, and said CO interface of said second access module.

33. The system of claim 25 wherein voice information carried within said established voice channel is carried in Internet protocol (IP) packets between said ONU that is connected to said first access module and said CO interface of said second access module.
